(19) United States
(12) Patent Application Publication
(10) Pub. No.: US 2024/0054686 A1
(43) Pub. Date: Feb. 15, 2024

(54) METHOD AND APPARATUS FOR CODING FEATURE MAP BASED ON DEEP LEARNING IN MULTITASKING SYSTEM FOR MACHINE VISION

(71) Applicants: HYUNDAI MOTOR COMPANY, Seoul (KR); KIA CORPORATION, Seoul (KR); EWHA UNIVERSITY - INDUSTRY COLLABORATION FOUNDATION, Seoul (KR)

(72) Inventors: Je Won Kang, Seoul (KR); Chae Hwa Yoo, Seoul (KR); Seung Wook Park, Yongin-si (KR); Wha Pyeong Lim, Hwaseong-si (KR)

(73) Assignees: HYUNDAI MOTOR COMPANY, Seoul (KR); KIA CORPORATION, Seoul (KR); EWHA UNIVERSITY - INDUSTRY COLLABORATION FOUNDATION, Seoul (KR)

(21) Appl. No.: 18/029,022

(22) PCT Filed: Sep. 29, 2021
(86) PCT No.: PCT/KR2021/013352

§ 371 Date: Oct. 9, 2023

(30) Foreign Application Priority Data
Sep. 29, 2020 (KR) 10-2020-0127284
Sep. 29, 2021 (KR) 10-2021-0128887

(51) Int. Cl. G06T 9/00; G06T 3/40; G06V 10/77; G06V 10/82

(52) U.S. Cl. CPC G06T 9/002; G06T 3/4046; G06V 10/7715; G06V 10/82

(57) ABSTRACT

A VCM coding apparatus and a VCM coding method, related to a deep learning-based feature map coding apparatus in a multitasking system for machine vision, are provided for performing default procedures of generating and compressing a common feature map related to multiple tasks implied by an original video. The VCM coding apparatus and the VCM coding method can further generate and compress a task-specific feature map whenever needed for higher performance than obtainable with the common feature map to ensure relatively acceptable performance for both machine vision and human vision.

### CROSS-REFERENCE TO RELATED APPLICATIONS

This application is a U.S. national stage of International Application No. PCT/KR2021/013352, filed on Sep. 29, 2021, which claims priority to Korean Patent Application No. 10-2020-0127284 filed on Sep. 29, 2020, and Korean Patent Application No. 10-2021-0128887 filed on Sep. 29, 2021, the entire disclosures of which are incorporated herein by reference.

### TECHNICAL FIELD

The present disclosure relates to an apparatus and a method for coding a feature map based on deep learning in a multitasking system for machine vision.

### BACKGROUND

The statements in this section merely provide background information related to the present disclosure and do not necessarily constitute prior art.

Machines are more generally recognized as the primary user of most of the video traffic as machine vision applications grow explosively with the development of deep learning technology and increased computing power. Machine-to-machine applications in the future are expected to account for the largest portion of Internet video traffic. Then, optimizing the information of video data used by machines can be a key factor in terms of innovation of video processing technology and commercialization of new solutions.

Existing video coding schemes are optimized for human vision because the video coding schemes aim for the best video or the highest video quality under specific bit rate constraints. On the other hand, the coding for machine vision does not necessarily take reconstructed images/videos of high visual performance. The advent of technical areas with strict limits on latency and scale, which include connected vehicles, Internet of Things (IoT) devices, ultra-large video surveillance networks, smart cities, quality inspection, etc., has ushered in a new paradigm for machine vision. This has prompted the need to provide a new image/video coding method in the machine vision's perspective.

Accordingly, Moving Picture Expert Group (MPEG), a standardization organization, has discussed the need for standardization for machine vision, resulting in Video Coding for Machines (VCM) proposed as the next-generation video codec that provides compression coding for machine vision and compression coding for human-machine hybrid vision.

While there may be various modifications available to the structure of the VCM codec, the basic structure of the VCM codec is illustrated in FIG. 16. Upon receiving a video, which is a sensor output, a VCM encoder extracts features as information for machine vision, converts the features to suit needs, and then performs feature encoding. Additionally, the VCM encoder may refer to encoded features when encoding inputted images or videos. Finally, the VCM encoder encodes the features for machine vision and the inputted images (or residual images) to generate bitstreams. The VCM encoder multiplexes the bitstreams each generated by encoding the features and video and transmits the multiplexed bitstreams together.

The VCM decoder demultiplexes the transmitted bitstreams into feature bitstreams and video bitstreams and then decodes the features and video, respectively. When decoding the video in this case, the VCM decoder may refer to reconstructed features. The reconstructed features can be used for machine vision and human vision simultaneously.

Meanwhile, a self-driving system is a multitasking system representative of the use cases of VCM technology. Here, the multiple tasks performed by the machine include multiple object detection, object segmentation, object (e.g., line) tracking, action recognition (or action localization), event prediction, etc. In general, a single-tasking deep learning model is trained for each task with videos obtained from sensors, such as a camera, infrared sensor, LiDAR, radar, and ultrasonic wave sensor, before the machine may perform the relevant tasks by using the learned single-task models, respectively.

An issue arises when a single-tasking model for each task is trained and the feature map of the learned model as information for machine vision is compressed and transmitted, because the greater the number of tasks, the greater the number of models requiring learning in proportion, with so much information to be transmitted. Therefore, VCM technology needs to be utilized with improved coding efficiency and with cost reduction by providing an appropriate deep learning model for a multitasking system and a learning method suited therefor.

### SUMMARY

The present disclosure in some embodiments seeks to provide a VCM coding apparatus and a VCM coding method. The VCM coding apparatus and the VCM coding method perform default procedures of generating and compressing a common feature map related to multiple tasks implied by an original video. The VCM coding apparatus and the VCM coding method can further generate and compress a task-specific feature map whenever needed for higher performance than obtainable with the common feature map to ensure relatively acceptable performance for both machine vision and human vision.

At least one aspect of the present disclosure provides a decoding method performed by a decoding apparatus for machine vision. The decoding method comprises obtaining a multiplexed bitstream. The decoding method also comprises obtaining, from the multiplexed bitstream, a first bitstream that is generated by encoding a common feature map representing a representative task that an original image implies. The decoding method also comprises decoding the common feature map from the first bitstream by using a common feature decoder. The decoding method also comprises generating a base image from the common feature map by using an image restoration model based on deep learning.

Another aspect of the present disclosure provides an encoding method performed by an encoding apparatus for machine vision. The encoding method comprises obtaining an original image. The encoding method also comprises extracting, from the original image, a common feature map representing a representative task that the original image implies, by using a common feature extraction model based on deep learning. The encoding method also comprises generating a first bitstream by encoding the common feature map by using a common feature encoder. The encoding method also comprises decoding a reconstructed common feature map from the first bitstream by using a common feature decoder and then generating a base image from the reconstructed common feature map by using an image restoration model based on deep learning.

Yet another aspect of the present disclosure provides a decoding apparatus for machine vision. The decoding apparatus comprises a demultiplexer configured to obtain, from a multiplexed bitstream, a first bitstream that is generated by encoding a common feature map representing a representative task that an original image implies. The decoding apparatus also comprises a common feature decoder configured to decode the common feature map from the first bitstream. The decoding apparatus also comprises a feature-to-image mapper configured to generate a base image from the common feature map by using an image restoration model based on deep learning.

### Advantageous Effects

As described above, the present disclosure in some embodiments provides a VCM coding apparatus and a VCM coding method. The VCM coding apparatus and the VCM coding method generate a common feature map related to multiple tasks implied by an original video and thus may ensure relatively acceptable performance for both machine vision and human vision and enable the transmission of an original video at a lower cost.

Additionally, according to some embodiments of the present disclosure, a VCM coding apparatus and a VCM coding method are provided to perform default procedures of generating and compressing a common feature map related to multiple tasks contained in an original video. The VCM coding apparatus and the VCM coding method further generate and compress a task-specific feature map and thus may ensure improved performance compared to a situation when receiving the common feature map alone from the perspective of machine vision and human vision.

Further, according to some embodiments of the present disclosure, a VCM coding apparatus and a VCM coding method are provided to perform default procedures of generating and compressing a common feature map related to multiple tasks contained in an original video. The VCM coding apparatus and the VCM coding method further generate and compress a task-specific feature map and thus may eliminate restrictions on the number of tasks performed by the VCM coding apparatus and obviate the need to restructure the VCM coding apparatus even with tasks added or deleted.

### BRIEF DESCRIPTION OF THE DRAWINGS

FIG. 1 is a conceptual block diagram of a video coding for machines (VCM) encoding apparatus according to at least one embodiment of the present disclosure.

FIG. 2 is a conceptual block diagram of a common feature extractor according to at least one embodiment of the present disclosure.

FIGS. 3A and 3B are conceptual diagrams of multitasking models according to at least one embodiment of the present disclosure.

FIG. 4 is a diagram illustrating a deep learning-based transformation model according to at least one embodiment of the present disclosure.

FIG. 5 is a diagram illustrating an auto-encoder for encoding and decoding a common feature map according to at least one embodiment of the present disclosure.

FIG. 6 is a diagram illustrating a deep learning-based image restoration model according to at least one embodiment of the present disclosure.

FIG. 7 is a conceptual block diagram of a task feature extractor according to at least one embodiment of the present disclosure.

FIG. 8 is a diagram illustrating an auto-encoder performing encoding and decoding of a task-specific feature map according to at least one embodiment of the present disclosure.

FIG. 9 is a diagram illustrating an auto-encoder for encoding and decoding a residual image according to at least one embodiment of the present disclosure.

FIG. 10 is a conceptual block diagram of a VCM decoding apparatus according to at least one embodiment of the present disclosure.

FIG. 11 is a conceptual block diagram of a VCM encoding apparatus according to another embodiment of the present disclosure.

FIG. 12 is a conceptual block diagram of a VCM decoding apparatus according to another embodiment of the present disclosure.

FIG. 13 is a conceptual block diagram of a VCM codec according to yet another embodiment of the present disclosure.

FIG. 14A and FIG. 14B are flowcharts of a VCM encoding method according to at least one embodiment of the present disclosure.

FIG. 15 is a flowchart of a VCM decoding method according to at least one embodiment of the present disclosure.

FIG. 16 is a conceptual block diagram of a VCM codec according to at least one embodiment of the present disclosure.

### DETAILED DESCRIPTION

Hereinafter, some embodiments of the present disclosure are described in detail with reference to the accompanying illustrative drawings. In the following description, like reference numerals designate like elements, although the elements are shown in different drawings. Further, in the following description of some embodiments, a detailed description of related known components and functions, where considered to obscure the subject of the present disclosure, has been omitted for the purpose of clarity and for brevity.

The embodiments disclose an apparatus and a method for coding a feature map based on deep learning in a multitasking system for machine vision. More specifically, to ensure relatively acceptable performance for both machine vision and human vision, the present disclosure in some embodiments provides a VCM (Video Coding for Machines) coding apparatus and a VCM coding method. The VCM coding apparatus and the VCM coding method perform default procedures of generating and compressing a common feature map related to multiple tasks implied by the original video and can further generate and compress a task-specific feature map whenever needed for higher performance than obtainable with the common feature map.

Here, the VCM coding apparatus or VCM codec includes a VCM encoding apparatus or device and a VCM decoding apparatus or device.

In the following description, an apparatus and a method for extracting a feature map from multiple tasks for machine vision and encoding and transmitting the extracted feature map are represented as a VCM encoding apparatus and method. An apparatus and method for decoding a feature map from a received bitstream are referred to as a VCM decoding apparatus and method. Accordingly, the VCM encoding apparatus and the VCM decoding apparatus according to the present disclosure may exemplify a multitasking system that performs multiple tasks.

Meanwhile, an existing codec for encoding and decoding a video signal to be optimized for human vision is represented by a video encoder and a video decoder.

In the following description, the number of tasks processed by the VCM encoding apparatus and the decoding apparatus is represented by N (where N is a natural number). Here, all tasks are assumed to be divided into S (where S is a natural number) sub-task sets T={T₁, T₂, . . . , Tₛ} as classified by the degree of similarity between tasks. T₁, T₂, . . . , T_{S} when assumed to be relatively prime (i.e., disjoint) satisfy that n(T₁)+n(T₂)+ , , , +n(T_{S})=N.

At this time, a set having the maximum number of elements among T₁, T₂, . . . , T_{S} is denoted by T* and defined as a representative task set. Here, the number of elements of the representative task set T* is represented by M (=n(T*), where M is a natural number). The individual tasks included in the representative task set are collectively defined as representative tasks. The complement set (T-T*) of the representative task set is defined as a residual task set. The tasks included in the residual task set are each defined as a residual task. Therefore, the number of residual tasks is N-M. When all tasks and the representative tasks coincide with each other, no residual task may exist.

Meanwhile, in some embodiments of the present disclosure, one or more sets of representative tasks may exist for all tasks.

One or more common feature maps represent the feature map(s) commonly used for the analysis of individual tasks included in a representative task set. The VCM encoding apparatus or the VCM decoding apparatus may utilize a common feature map to perform analysis on individual tasks included in the representative task set. For one representative task set, one or more common feature maps may exist.

The VCM encoding apparatus or the VCM decoding apparatus may, whenever necessary, utilize task-specific characteristics of the respective individual tasks to provide a better task analysis result, i.e., superior machine vision performance.

On the other hand, the present disclosure in some embodiments uses no common feature map for analysis of the residual tasks, but the present disclosure in some embodiments may utilize a task-specific feature map of each residual task to perform the task analysis. The process related to the task-specific feature map increases in linear proportion to the number of residual tasks. Therefore, the smaller the size of the residual task set, i.e., the smaller the number of residual tasks, the more advantageous in terms of compression efficiency and required time.

Task similarity used to divide all tasks into a set of partial tasks may be measured from an affinity matrix representing transferability between two tasks. Here, the transferability between two tasks represents the level of performance improvement between ex post facto learning of the target task applied directly with the feature representation of the neural network model learned on the source task and unassisted learning of the target task alone (see Non-Patent Document 1: Zamir, A. R., Sax, A., Shen, W., Guibas, L. J., Malik, J., & Savarese, S. (2018), Taskonomy: Disentangling task transfer learning, In Proceedings of the IEEE conference on computer vision and pattern recognition (pp. 3712-3722), which is incorporated herein by reference).

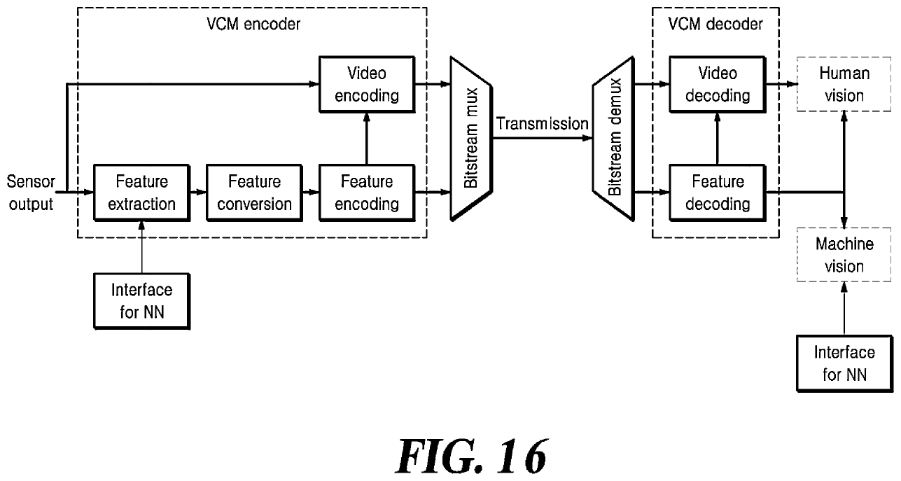

Meanwhile, when the number N of tasks is 1, the VCM encoding apparatus and the VCM decoding apparatus may be a single-tasking system as illustrated in FIG. 16.

The aforementioned process of dividing all the tasks into the representative task and residual task may be performed before VCM encoding and VCM decoding.

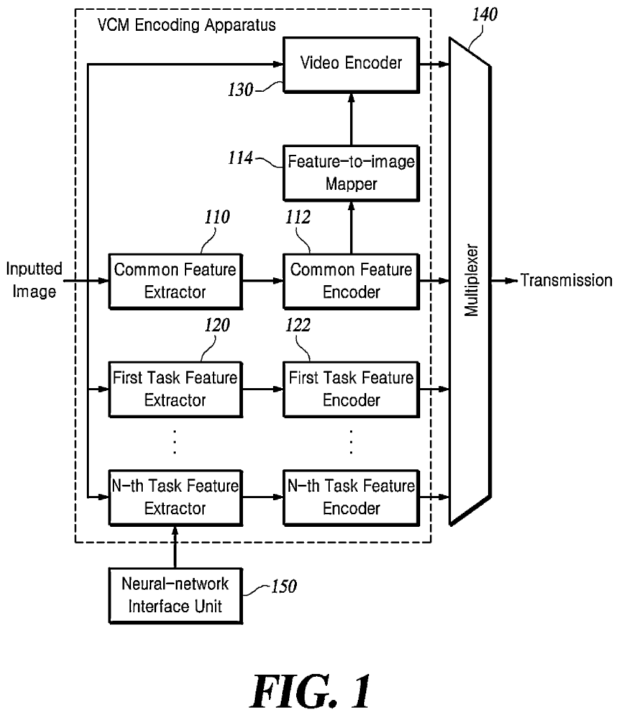

FIG. 1 is a conceptual block diagram of a VCM encoding apparatus according to at least one embodiment of the present disclosure.

The VCM encoding apparatus obtains video data corresponding to an output of a sensor or obtains inputted images. The VCM encoding apparatus extracts and encodes the common feature map of the representative task from the inputted images. When necessary, the VCM encoding apparatus extracts and encodes a task-specific feature map of individual tasks included in the representative task. The VCM encoding apparatus extracts and encodes a task-specific feature map of the residual task. When necessary, the VCM encoding apparatus utilizes a common feature map to generate a base image, generates a residual image by subtracting the base image from video data, and then encodes the residual image. The VCM encoding apparatus multiplexes bitstreams after encoding a common feature map, a task-specific feature map of individual tasks, a task-specific feature map of residual task, and residual images. Then the VCM encoding apparatus transmits the multiplexed bitstreams to the VCM decoding apparatus.

As illustrated in FIG. 1, the VCM encoding apparatus includes a common feature extractor 110, a common feature encoder 112, a feature-to-image mapper 114, and N task-feature extractors 120, N task-feature encoders 122, a video encoder 130, a multiplexer 140, and an interface unit 150 for neural networks in whole or in part. Here, components included in the VCM encoding apparatus according to the present disclosure are not necessarily limited to those illustrated. For example, to train a plurality of deep learning models included in the VCM encoding apparatus, the VCM encoding apparatus may be implemented in a configuration interlocking with an external training unit.

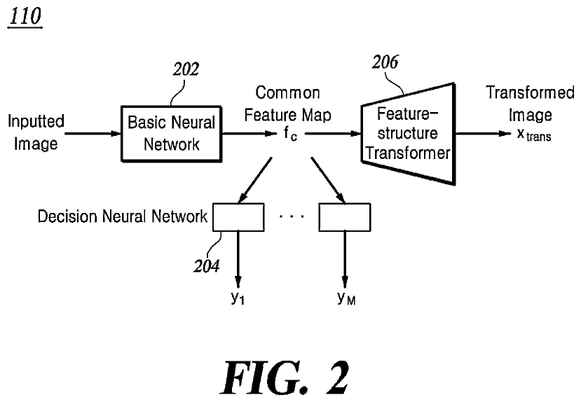

FIG. 2 is a conceptual block diagram of a common feature extractor 110 according to at least one embodiment of the present disclosure.

The common feature extractor 110 generates a common feature map of the representative task from the inputted images based on deep learning and generates analysis results of individual tasks included in the representative task. The common feature extractor 110 generates a transformed image from the common feature map based on deep learning. The common feature extractor 110 includes a basic neural network 202, M decision neural networks 204, and a feature-structure transformer 206 in whole or in part.

The following description uses the inputted images and original images as having the same meaning.

The basic neural network 202 generates a common feature map f_{c} from the inputted images.

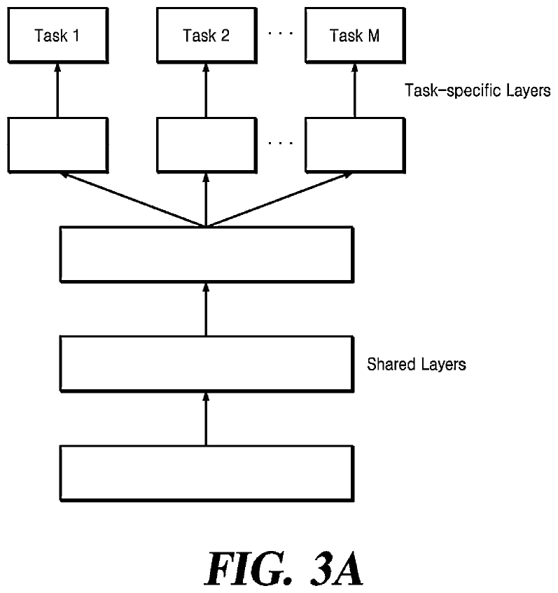

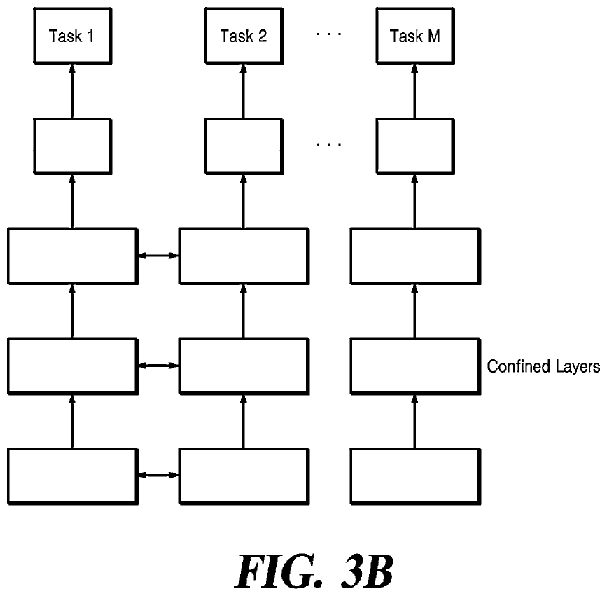

The basic neural network 202 is a deep learning model that underwent multi-task learning. The basic neural network 202 may be implemented as a multitasking deep learning model (see Non-Patent Document 2: Ruder, S., An overview of multi-task learning in deep neural networks, ARXIV:1706.05098, which is incorporated herein by reference) as illustrated in FIGS. 3A and 3B. In this case, the basic neural network 202 may be implemented as a convolutional neural network (CNN)-based deep learning model suitable for image processing.

In general, learning a model by configuring a deep learning-based learning model and a learning metric to achieve one or more objectives is called multi-task learning (MTL). Compared to a system specialized for a single task, a deep learning-based multitasking system designed to achieve multiple purposes may deteriorate performance. Multi-task learning is a learning method that generalizes a learning model to adapt to multiple tasks by sharing a representation learned for every single task. Multi-task learning, also called joint learning, learning to learn, or learning with auxiliary tasks, aims to optimize the performance of more than one task.

Deep learning-based multi-task learning uses two methods, including hard parameter sharing and soft parameter sharing, according to sharing of parameters included in a hidden layer. The hard parameter sharing, as illustrated in FIG. 3A, is a method of sharing a hidden layer among all tasks except for a single task-specific output layer and can reduce overfitting in the learning process. On the other hand, with soft parameter sharing, as illustrated in FIG. 3B, each task uses a model including its parameters, while normalizing the distance between the parameters of the model.

The common feature map generated by the basic neural network 202 is a feature commonly specialized for the respective tasks and may include the most representative information that can be shared between tasks based on multi-task learning.

The M decision neural networks 204 generate M outputs y₁, y₂ , , , y_{M} as analysis results related to individual tasks based on the common feature map. The analysis results may be used to determine whether to later perform detection and encoding of task-specific feature maps of individual tasks.

The M decision neural networks 204 may each be implemented as a fully-connected layer and an activation function.

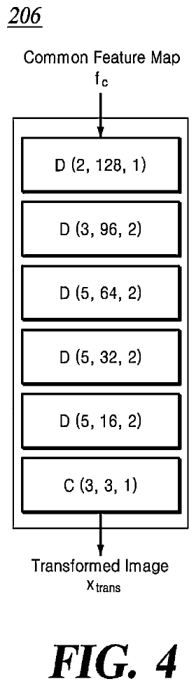

The feature-structure transformer 206 generates a transformed image xₜᵣₐₙₛ from the common feature map by using a deep learning-based transformation model. An embodiment of the deep learning-based transformation model is illustrated in FIG. 4. As illustrated in FIG. 4, D(a,b,c) represents a deconvolution layer, and C(a,b,c) represents a convolution layer. Additionally, a, b, and c represent the size of the convolution/deconvolution filter, the number of filters, and the stride, respectively. The transformed image xₜᵣₐₙₛ needs not have the same size as the original image x, and the transformed image xₜᵣₐₙₛ may be a low-resolution image well expressing the visual information of the original image in a set size.

The training unit may train the common feature extractor 110 end-to-end. At this time, as shown in Equation 1, a loss function is defined by a weighted sum of a loss function of individual tasks included in the representative task and an image reconstruction loss function for human vision.

$${L}_{common} = {\sum }_{i = 1}^{M} {α}_{i} {L}_{i} + β {L}_{I} \qquad [ Equation 1 ]$$

Here, Lᵢ is a loss for the i-th task among all M tasks, and αᵢ is a parameter adjusting the effect of the loss on the i-th task during learning. Image reconstruction loss L_{I} may be a loss commonly used for image reconstruction, such as a mean square error (MSE) loss, a sum of absolute transformed difference (SATD) loss, and the like. β is a parameter adjusting the effect of image reconstruction loss.

The common feature extractor 110 learned based on the loss function shown in Equation 1 cannot generate the best feature map for individual tasks because the common feature extractor 110 generates a common feature map covering all tasks as opposed to neural networks which are specialized for individual tasks and image reconstruction. However, the common feature map can provide basic performance for the representative task, and based on such basic performance, the common feature map can provide scalability for the individual tasks.

For example, when a machine simultaneously performs image classification and object detection, the basic neural network 202 of the common feature extractor 110 may have a structure that is branched at its certain portion that produces predicted values for each task as a result or a structure in which a certain portion of the result logit represents the predicted value for an individual task. At this time, the task loss function Lᵢ may be, for image classification, a cross-entropy loss between the label and the prediction yᵢ of the basic neural network and may be, for object recognition, a regression loss between the location of the actual object and the neural network's predicted position of that object. Additionally, the loss between the transformed image xₜᵣₐₙₛ reconstructed from the common feature map by the transformation model in the feature-structure transformer 206 and the corresponding original image is an image reconstruction loss function L_{I} for human vision.

The common feature encoder 112 generates a bitstream by encoding the common feature map f_{c} based on deep learning. Hereinafter, a bitstream after a common feature map is encoded is referred to as a first bitstream.

Inclusive of the common feature map f_{c}, a feature map of a general deep learning model has a size of (W, H, C). By correlating the size C of a channel with time, the common feature map may be assumed to be a video including C frames of W×H (Width×Height) size. Accordingly, the common feature encoder 112 may encode the common feature map by using an existing video codec, such as High Efficiency Video Coding (HEVC) or Versatile Video Coding (VVC). Alternatively, the common feature encoder 112 may encode a common feature map by using a deep learning-based auto-encoder.

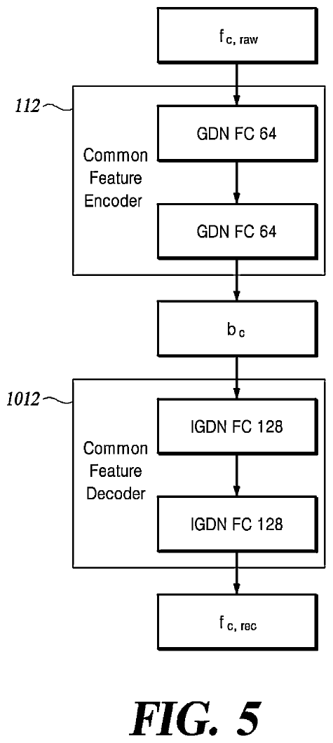

When using a deep learning-based auto-encoder, the training unit may train the common feature encoder 112, including a common feature decoder 1012, as illustrated in FIG. 5. The common feature decoder 1012 included in the VCM decoding apparatus is described below. At this time, the loss function is defined as shown in Equation 2.

L_{b}_{_{c}}=L₂(f_{c,raw},f_{c,rec})+λL₁(b_{c}) [Equation 2]

Here, L₂(·) denotes an L2 loss, and Lᵢ(·) denotes an L1 loss. Additionally, L₂ (f_{c,raw}, f_{c,rec}) represents a loss for reducing the difference between the transmitted common feature map f_{c,raw} and the reconstructed common feature map f_{c,rec}, and L₁ (b_{c}) represents a loss for reducing the number of transmitted bits b_{c} of the common feature map. λ is a parameter for adjusting influences during learning, for these two losses.

As illustrated in FIG. 5, GDN (Generalized Divisive Normalization) represents a nonlinear activation function used in the process of learning a nonlinear image transform. IGDN performs the inverse operation of GDN. For example, GDN FC 64 represents a 64-channel fully-connected layer that uses GDN as an activation function, and IGDN FC 128 represents a 128-channel fully-connected layer that uses IGDN as an activation function.

An auto-encoder is a deep learning model that copies inputs to outputs. The auto-encoder resembles a simple deep learning model but can generate a complex model by setting various constraints on the model. For example, the auto-encoder may constrain the hidden layer to have a smaller size than the input layer and thus compress data, i.e., reduce dimensionality. Alternatively, the auto-encoder may train the deep learning model to reconstruct the original input by adding noise to the input data. These constraints prevent the auto-encoder from simply copying inputs directly to outputs and allow the auto-encoder to learn how to provide the representation of data efficiently.

As illustrated in FIG. 5, an auto-encoder is always composed of two parts, including an encoder and a decoder. The present disclosure can set the output data of an encoder to have a smaller size than the input data to generate a bitstream by compressing input data.

In the above description, the common feature extractor 110 generates a transformed image xₜᵣₐₙₛ from the common feature map, but the present disclosure is not necessarily so limited. A VCM decoding apparatus to be described below generates a transformed image xₜᵣₐₙₛ from the common feature map reconstructed by using a preshared transformation model. In another embodiment of the present disclosure, the VCM encoding apparatus may further include a common feature decoder to decode the common feature map from the first bitstream generated by the common feature encoder 112. The VCM encoding apparatus may generate, from the decoded common feature map f_{rec}, a transformed image xₜᵣₐₙₛ by using a transformation model in the feature-structure transformer 206. Here, the transformation model is one of the components of the common feature extractor 110 pre-trained based on the loss function as shown in Equation 1.

The feature-to-image mapper 114 generates a base image x_{base} similar to the original image x from the transformed image xₜᵣₐₙₛ generated by the common feature extractor 110. The base image is an image of the minimum possible quality that could be generated later based on a common feature map reconstructed by the VCM decoding apparatus. Therefore, when more improved picture quality is required for human vision, the VCM encoding apparatus may use the video encoder 130 to provide an image having a more improved picture quality than the basic image.

The feature-to-image mapper 114 generates the base image x_{base} by inputting the transformed image xₜᵣₐₙₛ to a deep learning-based image restoration model composed of a deconvolution layer. Here, the image restoration model may be a model learned to output an image identical to the original image x.

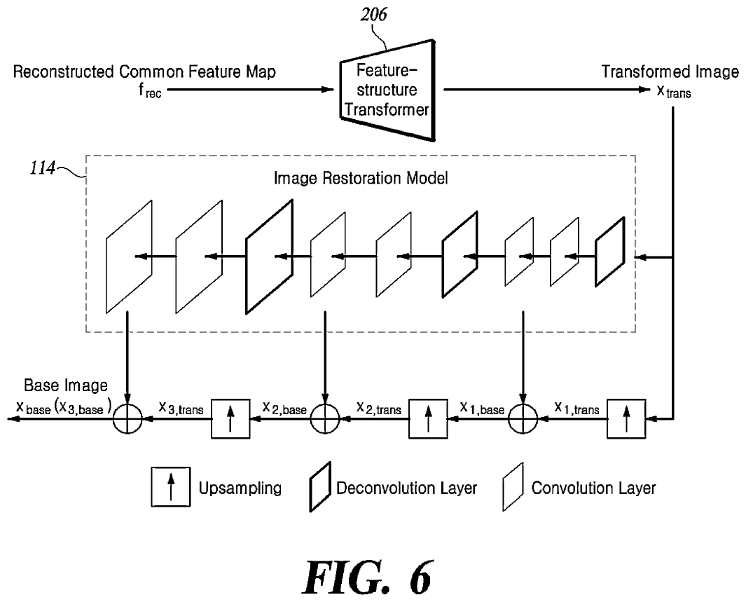

Meanwhile, the image restoration model may have a pyramidal structure, as illustrated in FIG. 6. The image restoration model has layers. An intermediate reconstructed image x_{k,base} is generated by adding the feature map outputted from the layer index k set at regular intervals or arbitrarily among the layers and an upsampled image x_{k,trans} to have the same size as that feature map. In the learning process of the image restoration model, by additionally reducing the loss between the intermediate reconstructed image x_{k,base} and the original image xₖ downsampled to the same size, the base image x_{base}, which is the output of the final stage of the image restoration model, allows for better reconstruction of visual information, in the high-frequency region, of the original image x.

The training unit may train the model of the pyramid structure by using a loss function as shown in Equation 3.

$${L}_{base} = {\sum }_{k = 1}^{K} {L}_{I} ( {x}_{k , base} , {x}_{k} ) \qquad [ Equation 3 ]$$

Here, the reconstruction loss L_{I}(·) may be a loss commonly used for image reconstruction, such as MSE loss and SATD loss. K (a natural number) is the number of pyramids in the image restoration model. K=1 with an image restoration model that takes account only of the loss between the output of the final stage and the original image but utilizes no pyramid structure. When K>1, x_{k,base} is an image outputted from the k-th pyramid, and xₖ is an original image downsampled to the same size as the image x_{k,base}.

Meanwhile, the VCM encoding apparatus is responsive to a situation when a task to be performed is a representative task, and to the need for further improved performance for the task, for extracting task-specific feature maps of individual tasks. Here, the case in need of further improved performance for the representative task is, for example, a case where the cumulative reliability of the analysis results generated by the M decision neural networks 204 below a predetermined threshold. This case gives an unsatisfactory analysis result for each individual task included in the representative task. At this time, according to the analysis result for each individual task, the VCM encoding apparatus may apply the task feature extractor 120 to all or some of the M individual tasks.

When a residual task is present and the task to be performed by the VCM encoding apparatus is the residual task, the task feature extractor 120 is used to extract a task-specific feature map of the residual task.

The VCM encoding apparatus may include M task feature extractors 120 to handle M individual tasks. The VCM encoding apparatus may include N-M task feature extractors 120 to perform the residual task. Parameters of components included in each task feature extractor 120 exist separately.

Based on deep learning, the task feature extractor 120 generates task-specific feature maps of the individual tasks included in the representative task or residual tasks from inputted images and generates analysis results of the individual tasks or residual tasks.

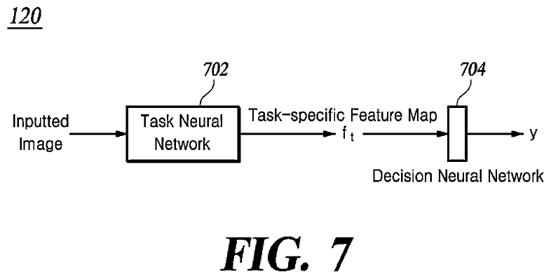

FIG. 7 is a conceptual block diagram of a task feature extractor 120 according to at least one embodiment of the present disclosure.

The task feature extractor 120 includes a task neural network 702 and a decision neural network 704.

The task neural network 702 is a deep learning model that underwent learning of the individual tasks or residual tasks.

The decision neural network 704 generates analysis results ‘y’ for the individual tasks or residual tasks. The decision neural network 704 may be implemented with a fully-connected layer and an activation function.

The training unit may use a loss function as shown in Equation 4 to train the task feature extractor 120.

Lₜₐₛₖ=L_{T}(y)+λL₁(fₜ) [Equation 4]

Here, L_{T}(·) of the first term is a loss commonly applied to the tasks, and L₁(·) of the second term represents a loss for reducing the number of transmission bits of the task-specific feature map. Also, λ is a parameter for adjusting influences during learning, for the two losses.

The VCM encoding apparatus may include M task feature encoders 122 to perform M individual tasks. The VCM encoding apparatus may include N-M task feature encoders 122 to perform residual tasks. When each task feature encoder 122 is implemented based on deep learning, the parameters of components included in each task feature encoder 122 exist separately.

The task feature encoder 122 encodes a task-specific feature map based on deep learning to generate a bitstream. Hereinafter, a bitstream obtained by encoding a task-specific feature map of an individual task is referred to as a second bitstream. The following further refers to a bitstream obtained by encoding a task-specific feature map of a residual task as a third bitstream.

Similar to the common feature map, the task-specific feature map has a size of (W, H, C). Hence, the task-specific feature map may be assumed to be a video including as many as C frames of W×H size. Accordingly, the task feature encoder 122 may encode a task-specific feature map by using an existing video codec such as HEVC or VVC. Alternatively, the task feature encoder 122 may encode a task-specific feature map by using a deep learning-based auto-encoder.

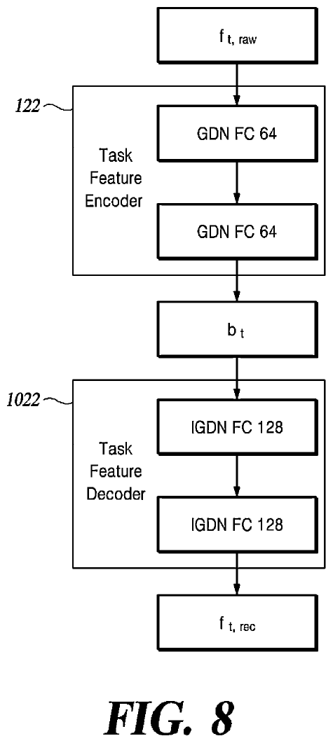

When using a deep learning-based auto-encoder, the training unit may train the task feature encoder 122, inclusive of a task feature decoder 1022, as illustrated in FIG. 8. The task feature decoder 1022 included in the VCM decoding apparatus is described below. At this time, the loss function is defined as shown in Equation 5.

L_{b}_{ₜ}=L₂(f_{t,raw},f_{t,rec})+λL₁(bₜ) [Equation 5]

Here, L₂(·) denotes an L2 loss, and L₁(·) denotes an L1 loss. Additionally, L₂(f_{t,raw}, f_{t,rec}) represents a loss for reducing the difference between a transmitted task-specific feature map f_{t,raw} and a reconstructed task-specific feature map f_{t,rec}, and L₁(bₜ) represents the loss for reducing the number of transmitted bits bₜ of the task-specific feature map. Also, λ is a parameter for adjusting influences during learning, for the two losses.

When the need arises for a more improved image than the base image generated by the feature-to-image mapper 114 to satisfy human vision, the VCM encoding apparatus may use the video encoder 130 to encode a residual image required for the generation of a better-reconstructed image and thereby generate a bitstream. Hereinafter, a bitstream obtained by encoding a residual image is referred to as a fourth bitstream.

A residual image is a texture generated by subtracting a base image from the inputted images. Accordingly, the video encoder 130 may also be referred to as a texture encoder.

The video encoder 130 may be implemented by using an existing video codec such as HEVC, VVC, or the like. Alternatively, it may be implemented by using a deep learning-based auto-encoder.

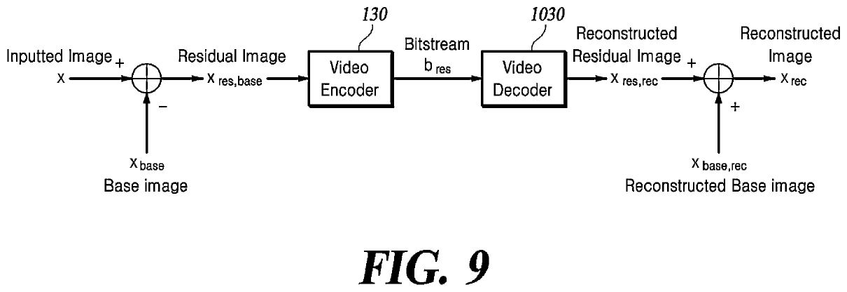

When using a deep learning-based auto-encoder, as FIG. 9 illustrates, the training unit may train the video encoder 130, inclusive of a video decoder 1030. The video decoder 1030 included in the VCM decoding apparatus is described below. At this time, the loss function is defined as shown in Equation 6.

L_{b}_{ᵣₑₛ}=L_{I}(x_{res,raw},x_{res,rec})±λL₁(bᵣₑₛ) [Equation 6]

Here, the reconstruction loss L_{I}(·) may be a loss commonly used for video reconstruction, such as MSE loss or SATD loss, or it may be an L2 loss. L₁(·) represents the L1 loss. Additionally, L₂(f_{res,raw}, f_{res,rec}) represents a loss for reducing the difference between a residual image and a reconstructed residual image, and L₁(bᵣₑₛ) represents a loss for reducing the transmission bit number bᵣₑₛ of the residual image. λ is a parameter for adjusting influences during learning, for the two losses.

The multiplexer 140 multiplexes all or some of the first bitstream generated by the common feature encoder 112, a second bitstream and a third bitstream both generated by the N task feature encoders 122, and a fourth bitstream generated by the video encoder 130 to generate a multiplexed bitstream and then transmits the latter to the VCM decoding apparatus.

At this time, the VCM encoding apparatus may send the VCM decoding apparatus flags indicating the presence of each of the second bitstream, the third bitstream, and the fourth bitstream.

The neural-network interface unit 150 is a module that stores information (e.g., parameters) of the deep learning models used by the VCM encoding apparatus. The neural-network interface unit 150 stores parameters of deep learning models trained by the training unit but is not necessarily a component of the VCM encoding apparatus.

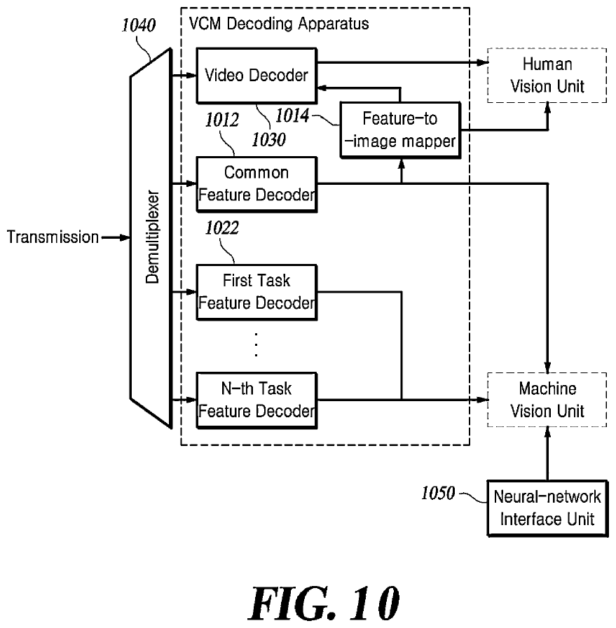

FIG. 10 is a conceptual block diagram of a VCM decoding apparatus according to at least one embodiment of the present disclosure.

The VCM decoding apparatus obtains a multiplexed bitstream and thereby obtains bitstreams corresponding to a common feature map, task-specific feature maps of the individual tasks and residual tasks, and a residual image. The VCM decoding apparatus decodes the common feature map from the bitstream. When necessary, the VCM decoding apparatus decodes task-specific feature maps of individual tasks included in the representative task. The VCM decoding apparatus decodes the task-specific feature maps of the residual tasks. When necessary, the VCM decoding apparatus generates a base image by using the reconstructed common feature map, decodes a residual image from the bitstream, and then adds the base image to the residual image to generate a reconstructed video image. As illustrated in FIG. 10, the VCM decoding apparatus includes a common feature decoder 1012, a feature-to-image mapper 1014, N task-feature decoders 1022, a video decoder 1030, a demultiplexer 1040, and a neural-network interface unit 1050 in whole or in part.

The demultiplexer 1040 demultiplexes, from the multiplexed bitstream, the first bitstream to be used by the common feature decoder 1012, the second bitstream and the third bitstream to be used by the N task feature decoders 1022, and the fourth bitstream to be used by the video decoder 1030.

At this time, the VCM decoding apparatus may demultiplex the multiplexed bitstream by using flags each indicating the presence of each of the second bitstream, the third bitstream, and the fourth bitstream.

The common feature decoder 1012 decodes a common feature map from the first bitstream. The common feature decoder 1012 may decode the common feature map by using an existing video codec. Alternatively, the common feature decoder 1012 may decode the common feature map by using a deep learning-based auto-encoder.

When using a deep learning-based auto-encoder, as illustrated in FIG. 5, the common feature decoder 1012 may be pre-trained, inclusive of the common feature encoder 112. The loss function is defined as shown in Equation 2, as described above, so a detailed description thereof is omitted.

The feature-to-image mapper 1014 is responsive to the need for a reconstructed image for the human vision for generating a transformed image xₜᵣₐₙₛ from the decoded common feature map f_{rec} and then generating, from the transformed image xₜᵣₐₙₛ, abase image x_{base} similar to the original image x. The basic video is a video with the minimum possible quality that can be provided by the VCM decoding apparatus.

The VCM decoding apparatus may include the feature-structure transformer 206, as illustrated in FIG. 4, and may use a deep learning-based transformation model in the feature-structure transformer 206 to generate the transformed image xₜᵣₐₙₛ from the reconstructed common feature map. In the VCM decoding apparatus, the feature-structure transformer 206 may be included as a part of the feature-to-image mapper 1014.

The feature-to-image mapper 1014 may use a deep learning-based image restoration model to generate, from the transformed image xₜᵣₐₙₛ, a base image x_{base} similar to the original image x. Meanwhile, the image restoration model may have a pyramidal structure as illustrated in FIG. 6. Additionally, the model of the pyramid structure is pre-trained by using the loss function as shown in Equation 3.

On the other hand, the VCM decoding apparatus is responsive to a situation when the task to be handled is a representative task and when receiving a transmitted task-specific feature map of an individual task due to the need for more improved performance for the representative task, and is for decoding, from the second bitstream, the task-specific feature maps of the individual tasks by using the task feature decoder 1022. At this time, depending on the analysis result of the individual tasks, the task feature decoder 1022 may be applied to all or some of the M individual tasks.

Upon receiving the transmitted task-specific feature map of the residual task, the VCM decoding apparatus decodes the task-specific feature map of the residual task from the third bitstream by using the task feature decoder 1022.

The VCM decoding apparatus may include M task feature decoders 1022 to perform M individual tasks. The VCM decoding apparatus may include N-M task feature decoders 1022 to perform the residual task. When the respective task feature decoders 1022 are implemented based on deep learning, the parameters of components included in each task feature decoder 1022 exist separately.

The task feature decoder 1022 may decode the task-specific feature map by using an existing video codec. Alternatively, the task-specific feature map may be decoded by using a deep learning-based auto-encoder.

When using a deep learning-based auto-encoder, as illustrated in FIG. 8, the task feature decoder 1022 may be pre-trained, inclusive of the task feature encoder 122. The loss function is defined as shown in Equation 5 as described above, so a detailed description thereof is omitted.

Meanwhile, in a machine vision unit illustrated by the dotted-line box in FIG. 10, the decoded common feature map and task-specific feature map may be used to perform an analysis of the individual tasks or residual tasks included in the representative task.

Responsive to a residual image transmitted to provide a more improved image for satisfying human vision, the VCM decoding apparatus may decode the residual image from the fourth bitstream by using the video decoder 1030. Additionally, the video decoder 1030 may add the residual image and the base image to generate a reconstructed image. For example, a human vision unit illustrated by a dotted-line box in FIG. 10 may use, whenever needed, a base image or a reconstructed image selectively.

As with the video encoder 130 being referred to as a texture encoder, the video decoder 1030 may be referred to as a texture decoder.

As described above, the video decoder 1030 may decode the residual image by using an existing video codec. Alternatively, the residual image may be decoded by using a deep learning-based auto-encoder.

When using a deep learning-based auto-encoder, as illustrated in FIG. 9, the video decoder 1030 may be pre-trained, inclusive of the video encoder 130. The loss function is defined as shown in Equation 6, as described above, so a detailed description thereof is omitted.

The neural-network interface unit 1050 is a module that stores information (e.g., parameters) of deep learning models used by the VCM decoding apparatus. The neural-network interface unit 1050 stores parameters of deep learning models trained by the training unit but does not have to be a component of the VCM decoding apparatus.

The illustrations of FIGS. 1 and 10 are those of configurations according to the embodiments of the present disclosure, which are subject to change in configuration depending on what task the VCM coding apparatus, i.e., the multitasking system performs and the machine's or human's required performance level in terms of machine vision and human vision.

Additionally, in the architecture of the initially set multitasking system, the components may be expansively added or deleted in concert with the addition or deletion of tasks to be performed by the multitasking system or in concert with the required performance level of the machine and the user changed in terms of machine vision and human vision.

In the drawings of FIGS. 1 and 10, the multitasking system is illustrated in the aspect of a VCM coding apparatus, but the multitasking system may alternatively be described in a hierarchical structure. In terms of tasks, the multitasking system includes a common feature layer that performs a representative task, a task-specific feature layer that performs an individual task or residual task, and an image reconstruction layer that processes an image.

The common feature layer is a layer that extracts a common feature map of a representative task from the inputted image and encodes and decodes the extracted common feature map. The common feature layer includes a common feature extractor 110, a common feature encoder 112, a common feature decoder 1012, and a feature-to-image mapper 114 (or 1014). The operation of each component of the common feature layer is described above, so further description thereof is omitted.

The common feature layer is a layer that is preferentially and/or necessarily set and executed in the multitasking system. The common feature layer provides a certain minimum performance for the representative tasks by using a common feature map and guarantees minimum picture quality in terms of human vision by using a base image. The other two layers selectively compress and transmit information related to the layers only when the machine and the user need it once the components included in the encoder are generated in advance.

The task-specific feature layer is a layer that extracts task-specific feature maps of the individual task and residual task from the inputted image and encodes and decodes the extracted task-specific feature maps. The task-specific feature layer includes a task feature extractor 120, a task feature encoder 122, and a task feature decoder 1022. The operation of each component of the task-specific feature layer is described above, so further description thereof is omitted.

The task-specific feature layer transmits information when a machine needs improved performance over a guaranteed minimum performance for a representative task or needs analysis for residual tasks.

The image reconstruction layer generates a reconstructed image from a residual image of an inputted image based on a common feature map. The image reconstruction layer includes a video encoder 130 and a video decoder 1030. The operation of each component of the image reconstruction layer is described above, so further description thereof is omitted.

The image reconstruction layer transmits information when a user requests a reconstructed image having a quality higher than the minimum quality provided by the basic video.

The above description of the multitasking system, i.e., the VCM coding apparatus assumes the presence of one representative task and one residual task. In another embodiment according to the present disclosure, when one representative task includes a main task and sub-tasks, the multitasking system may be modified to perform the main task and the sub-tasks.

For example, if there exists, among the constituent tasks of the representative task set, one task that is characteristic enough to share the most closely related information with other tasks and to set the other tasks as sub-tasks of the one task, then this characteristic task is defined as the main task and the other tasks are defined as sub-tasks. At this time, the residual tasks are set to be non-existent.

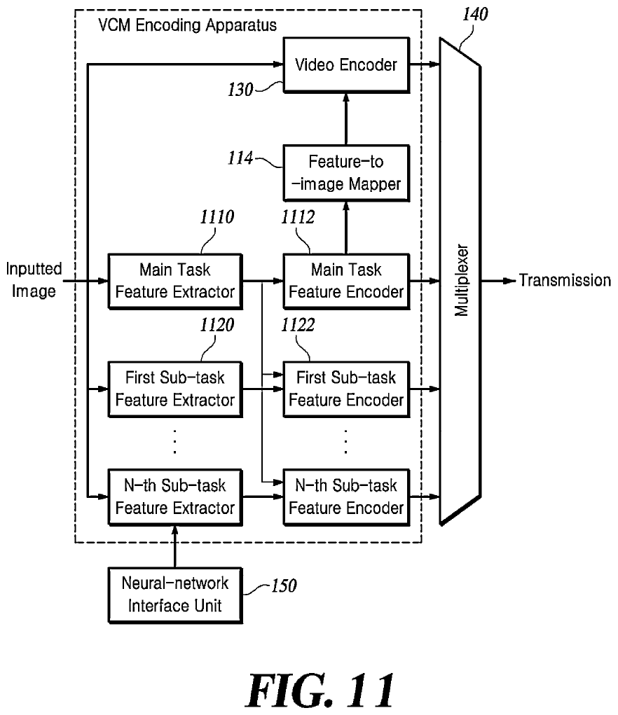

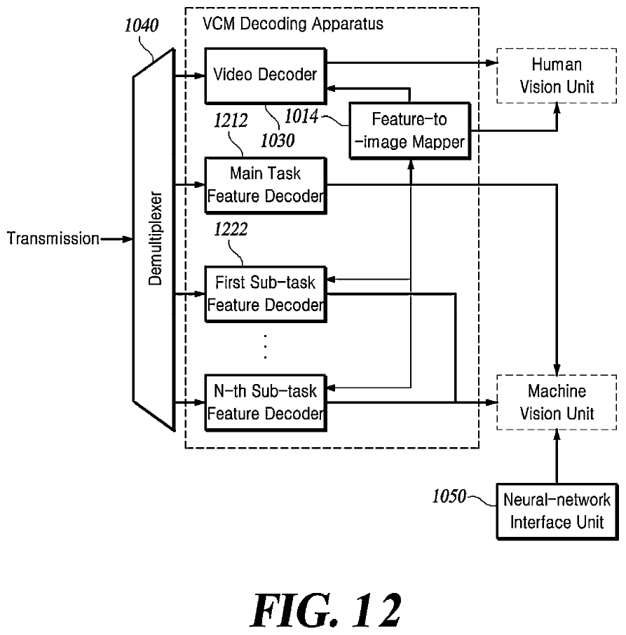

The following describes VCM encoding apparatuses and VCM decoding apparatuses for performing one main task and N sub-tasks by using examples of FIGS. 11 and 12.

FIG. 11 is a conceptual block diagram of a VCM encoding apparatus according to another embodiment of the present disclosure.

The VCM encoding apparatus illustrated in FIG. 11 includes a main task feature extractor 1110 and a main task feature encoder 1112 as components for performing a main task, and includes N sub-task feature extractors 1120 and N sub-task feature encoders 1122 as components for performing sub-tasks. The remaining components of the VCM encoding apparatus are the same as those in the example of FIG. 1.

FIG. 12 is a conceptual block diagram of a VCM decoding apparatus according to another embodiment of the present disclosure.

The VCM decoding apparatus illustrated in FIG. 12 includes a main task feature decoder 1212 to perform a main task and N sub-task feature decoders 1222 to perform sub-tasks. The remaining components of the VCM decoding apparatus are the same as those in the example of FIG. 10.

Performing the main task by the VCM encoding apparatus and the VCM decoding apparatus in the examples of FIGS. 11 and 12 is similar to performing the representative task in the common feature layer, as illustrated in FIGS. 1 and 10. Accordingly, the VCM encoding apparatus and the VCM decoding apparatus may use the feature-to-image mappers 114 and 1014 to generate a base image from the main task-specific feature map generated by the main task feature decoder 1212.

In the examples of FIGS. 11 and 12, the VCM encoding apparatus and the VCM decoding apparatus performing sub-tasks are like performing the individual tasks or residual tasks in the task-specific feature layer as illustrated in FIGS. 1 and 10.

In the examples of FIGS. 11 and 12, the components performing the main task and the components performing the sub-tasks may have the same architecture. However, the sub-task feature encoder 1122 may generate a residual frame of the sub-task-specific feature map by using the main task-specific feature map as a reference frame and then transmit the residual frame.

Meanwhile, as described above, when classifying tasks by the degree of similarity between the tasks, a plurality of representative task sets may be set having no significant difference between them in the number of constituent tasks. In another embodiment according to the present disclosure, the multitasking system may perform a plurality of representative tasks by using a plurality of representative task subgroups. At this time, the respective subgroups operate independently of each other while including components for processing a common feature map and a task-specific feature map, i.e., a common feature layer and a task-specific feature layer, and no information is present to be shared between the subgroups.

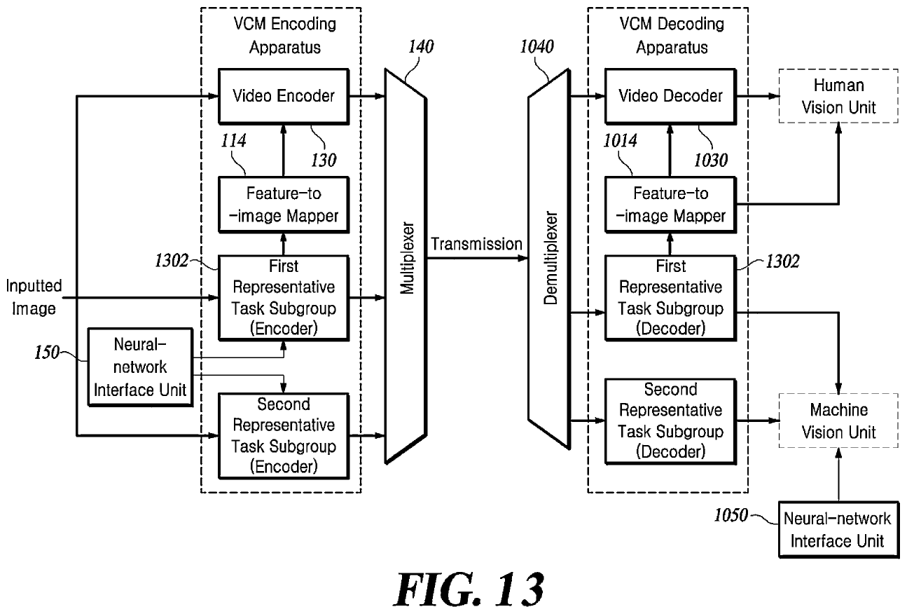

FIG. 13 is a conceptual block diagram of a VCM codec according to yet another embodiment of the present disclosure.

The specifics in FIG. 13 illustrate a VCM encoding codec performing two representative tasks. Here, the VCM encoding apparatus and the VCM decoding apparatus each have representative task subgroups 1302 including all components as illustrated in FIGS. 1 and 10 for processing a common feature map and N task-specific feature maps.

As illustrated in FIG. 13, the VCM codec performs image reconstruction by using the common feature map generated by the first representative task subgroup, but the present disclosure is not necessarily so limited. The VCM codec may use any common feature map generated by subgroups included in the encoding apparatus for image reconstruction. Additionally, the VCM codec may perform image reconstruction by using common feature maps generated by all or some of the subgroups included in the encoding apparatus.

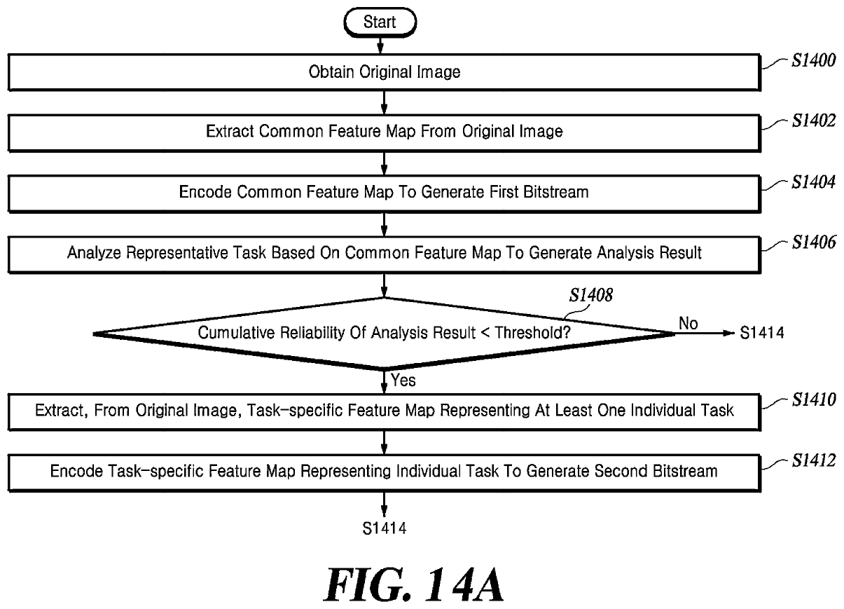

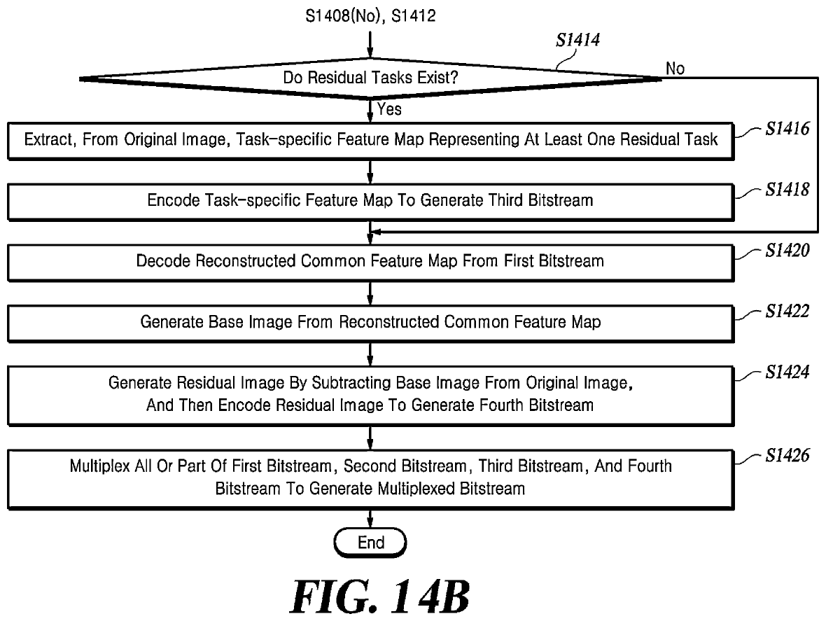

FIG. 14A and FIG. 14B are flowcharts of a VCM encoding method according to at least one embodiment of the present disclosure.

The VCM encoding apparatus obtains an original image (S1400).

The VCM encoding apparatus extracts a common feature map from the original image by using a deep learning-based common feature extraction model (S1402). Here, the common feature map represents a representative task that the original image implies. The aforementioned common feature extractor 110 represents a deep learning-based common feature extraction model.

The common feature extractor 110 includes the basic neural network 202, the decision neural network 204, and transformation models corresponding to the feature-structure transformer 206. The common feature extractor 110 extracts the common feature map from the original image by using the basic neural network, generates an analysis result of the representative task based on the common feature map by using the decision neural network, and uses the transformation models to generate a transformed image from the common feature map.

The VCM encoding apparatus encodes the common feature map by using the common feature encoder 112 to generate a first bitstream (S1404).

The VCM encoding apparatus generates an analysis result of the representative task based on the common feature map by using the decision neural network 204 (S1406).

The VCM encoding apparatus checks whether the cumulative reliability of the analysis result is less than a preset threshold (S1408).

When the cumulative reliability of the analysis result is less than the preset threshold (Yes in S1408), the VCM encoding apparatus may generate a second bitstream.

The VCM encoding apparatus extracts, from the original image, a task-specific feature map representing at least one individual task by using a task-feature extraction model based on deep learning (S1410). Here, at least one individual task is included in the representative task. The aforementioned task feature extractor 120 represents the task-feature extraction model based on deep learning.

The VCM encoding apparatus encodes the task-specific feature map representing the individual task by using the task feature encoder 122 to generate a second bitstream (S1412). The task feature encoder may be implemented with a video signal encoder or a deep learning-based auto-encoder.

When the cumulative reliability of the analysis result is greater than or equal to the preset threshold (No in S1408), the VCM encoding apparatus checks whether at least one residual task exists (S1414).

When there is at least one residual task (Yes in S1414), the VCM encoding apparatus may generate a third bitstream.

The VCM encoding apparatus extracts, from the original image, the task-specific feature map representing the residual task by using the task feature extractor 120 (S1416).

The task feature extractor 120 includes a task neural network 702 and a decision neural network 704. The task feature extractor 120 may extract the task-specific feature map from the original image by using the task neural network 702 and use the decision neural network 704 to generate the analysis result of the individual task or residual tasks based on the task-specific feature map.

The VCM encoding apparatus encodes the task-specific feature map representing the residual tasks by using the task feature encoder 122 to generate a third bitstream (S1418).

To take account of a case where no residual task is present but an improved image is required in terms of human vision (No in S1414), the VCM encoding apparatus may generate a fourth bitstream.

The VCM encoding apparatus decodes the reconstructed common feature map from the first bitstream by using the common feature decoder 1012 (S1420).

Here, the above-described common feature encoder and common feature decoder may be implemented by using a video signal codec or a deep learning-based auto-encoder.

The VCM encoding apparatus generates a base image from a reconstructed common feature map by using a deep learning-based image restoration model (S1422). For example, the VCM encoding apparatus may generate a transformed image from the reconstructed common feature map by using the transformation model and then generate a base image from the transformed image by using the image restoration model. The aforementioned feature-to-image mapper 114 represents the deep learning-based image restoration model.

The VCM encoding apparatus generates a residual image by subtracting the base image from the original image by using the video encoder 130 and then encodes the residual image to generate a fourth bitstream (S1424).

The video encoder 130 may be implemented by using a video signal encoder or a deep learning-based auto-encoder.

The VCM encoding apparatus multiplexes at least parts of the first bitstream, the second bitstream, the third bitstream, and the fourth bitstream to generate a multiplexed bitstream (S1426). The VCM encoding apparatus transmits the multiplexed bitstream to the VCM decoding apparatus. In this case, the VCM encoding apparatus may send the VCM decoding apparatus flags indicating the presence of each of the second bitstream, the third bitstream, and the fourth bitstream.

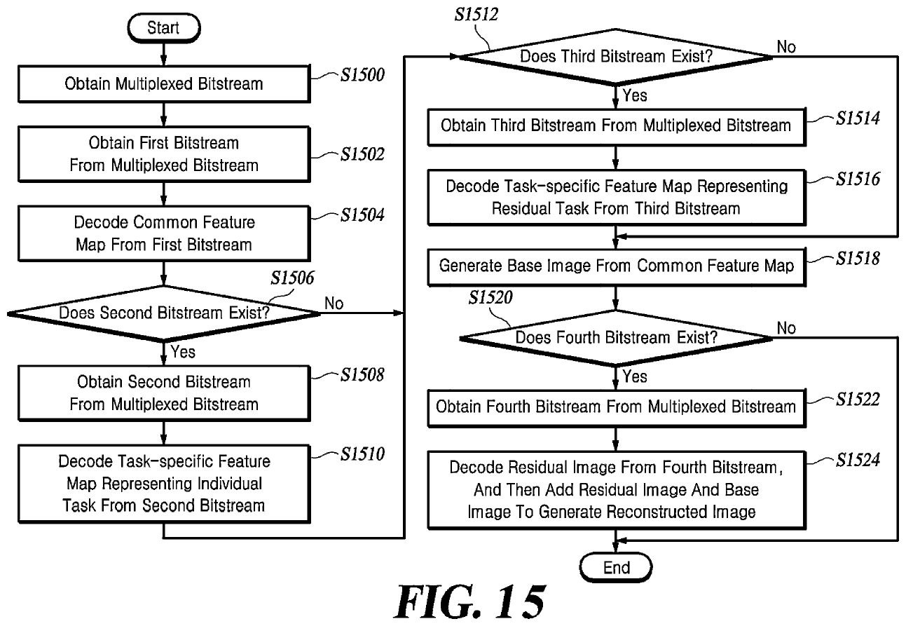

FIG. 15 is a flowchart of a VCM decoding method according to at least one embodiment of the present disclosure.

The VCM decoding apparatus obtains a multiplexed bitstream transmitted from the VCM encoding apparatus (S1500). In this case, the VCM decoding apparatus may demultiplex the multiplexed bitstream by using the flags indicating the presence of each of the second bitstream, the third bitstream, and the fourth bitstream.

The VCM decoding apparatus obtains a first bitstream from the multiplexed bitstream (S1502). Here, the first bitstream is one obtained by encoding a common feature map representing a representative task.

The VCM decoding apparatus decodes the common feature map from the first bitstream by using the common feature decoder 1012 (S1504). Here, the common feature decoder 1012 may be implemented by using a conventional video signal decoder or a deep learning-based auto-encoder.

When the VCM encoding apparatus transmitted the second bitstream, the multiplexed bitstream may include the second bitstream. Here, the second bitstream is one obtained by encoding a task-specific feature map representing at least one individual task included in the representative task.

The VCM decoding apparatus checks whether the second bitstream exists in the multiplexed bitstream (S1506).

When the second bitstream exists (Yes in S1506), the VCM decoding apparatus obtains the second bitstream from the multiplexed bitstream (S1508).

The VCM decoding apparatus decodes the task-specific feature map representing the individual task from the second bitstream by using the task feature decoder 1022 (S1510). Here, the task feature decoder 1022 may be implemented by using an existing video signal decoder or a deep learning-based auto-encoder.

When the second bitstream does not exist but the VCM encoding apparatus transmitted the third bitstream (No in S1506), the multiplexed bitstream may include the third bitstream. Here, the third bitstream is one obtained by encoding a task-specific feature map representing at least one residual task.

The VCM decoding apparatus checks whether a third bitstream exists in the multiplexed bitstream (S1512).

When the third bitstream exists (Yes in S1512), the VCM decoding apparatus obtains the third bitstream from the multiplexed bitstream (S1514).

The VCM decoding apparatus decodes the task-specific feature map representing the residual task from the third bitstream by using the task feature decoder 1022 (S1516).

When no third bitstream exists, but an image is required from the perspective of human vision (No in S1512), the VCM decoding apparatus generates a base image from the common feature map by using a deep learning-based image restoration model (S1518). For example, the VCM decoding apparatus may generate a transformed image from the common feature map by using a deep learning-based transformation model and then generate a base image from the transformed image by using an image restoration model. The aforementioned feature-to-image mapper 114 represents the deep learning-based image restoration model.

When the VCM encoding apparatus transmits the fourth bitstream to provide an image that is more improved than the base image in terms of human vision, the multiplexed bitstream may include the fourth bitstream. Here, the fourth bitstream is one obtained by encoding a residual image generated by subtracting the base image from the original image.

The VCM decoding apparatus checks whether a fourth bitstream exists in the multiplexed bitstream (S1520).

When the fourth bitstream exists (Yes in S1520), the VCM decoding apparatus obtains the fourth bitstream from the multiplexed bitstream (S1522).

The VCM decoding apparatus decodes the residual image from the fourth bitstream by using the video decoder 1030 and then adds the residual image and the base image to generate a reconstructed image (S1524). Here, the video decoder 1030 may be implemented by using an existing video signal decoder or a deep learning-based auto-encoder.

Although the steps in the respective flowcharts are described to be sequentially performed, the steps merely instantiate the technical idea of some embodiments of the present disclosure. Therefore, a person having ordinary skill in the art could perform the steps by changing the sequences described in the respective drawings or by performing two or more of the steps in parallel, and hence the steps in the respective flowcharts are not limited to the illustrated chronological sequences.

It should be understood that the above description presents illustrative embodiments that may be implemented in various other manners. The functions described in some embodiments may be realized by hardware, software, firmware, and/or their combination. It should also be understood that the functional components described in this specification are labeled by “ . . . unit” to strongly emphasize the possibility of their independent realization.

Meanwhile, various methods or functions described in some embodiments may be implemented as instructions stored in a non-transitory recording medium that can be read and executed by one or more processors. The non-transitory recording medium includes, for example, all types of recording devices in which data is stored in a form readable by a computer system. For example, the non-transitory recording medium may include storage media such as erasable programmable read-only memory (EPROM), flash drive, optical drive, magnetic hard drive, and solid state drive (SSD) among others.

Although embodiments of the present disclosure have been described for illustrative purposes, those having ordinary skill in the art should appreciate that various modifications, additions, and substitutions are possible, without departing from the idea and scope of the present disclosure. Therefore, embodiments of the present disclosure have been described for the sake of brevity and clarity. The scope of the technical idea of the embodiments of the present disclosure is not limited by the illustrations. Accordingly, one of ordinary skill should understand the scope of the present disclosure is not to be limited by the above explicitly described embodiments but by the claims and equivalents thereof.

### REFERENCE NUMERALS

110: common feature extractor
112: common feature encoder
114: feature-to-image mapper
120: task feature extractor
122: task feature encoder
130: video encoder
140: multiplexer
150: neural-network interface unit
1012: common feature decoder
1014: feature-to-image mapper
1022: task feature decoder
1030: video encoder
1040: multiplexer
1050: neural-network interface unit

1. A decoding method performed by a decoding apparatus for machine vision, the decoding method comprising:
obtaining a multiplexed bitstream;
obtaining, from the multiplexed bitstream, a first bitstream that is generated by encoding a common feature map representing a representative task that an original image implies;
decoding the common feature map from the first bitstream by using a common feature decoder; and
generating a base image from the common feature map by using an image restoration model based on deep learning.

2. The decoding method of claim 1, further comprising:
when a second bitstream is included in the multiplexed bitstream, obtaining, from the multiplexed bitstream, the second bitstream that is generated by encoding a task-specific feature map that represents at least one or more individual tasks included in the representative task; and
decoding the task-specific feature map that represents the individual task from the second bitstream by using a task feature decoder.

3. The decoding method of claim 2, further comprising:
when a third bitstream is included in the multiplexed bitstream, obtaining, from the multiplexed bitstream, the third bitstream that is generated by encoding a task-specific feature map that represents at least one or more residual tasks; and
decoding the task-specific feature map that represents the residual task from the third bitstream by using the task feature decoder.

4. The decoding method of claim 1, further comprising:
when a fourth bitstream is included in the multiplexed bitstream, obtaining, from the multiplexed bitstream, the fourth bitstream that is generated by encoding a residual image generated by subtracting the base image from the original image; and
decoding the residual image from the fourth bitstream by using a video decoder, and then generating a reconstructed image by adding the residual image and the base image.

5. The decoding method of claim 2, wherein the common feature decoder and the task feature decoder are each implemented by using a decoder for video signals or an auto-encoder based on deep learning.

6. The decoding method of claim 1, wherein the generating of the base image comprises:
generating a transformed image from the common feature map by using a transformation model based on deep learning and then generating the base image from the transformed image by using the image restoration model.

7. The decoding method of claim 6, wherein the transformation model is configured to be pre-trained by using a loss function based on a difference between the original image and the transformed image, and
wherein the image restoration model is pre-trained by using a loss function based on a difference between the original image and the base image.

8. An encoding method performed by an encoding apparatus for machine vision, the encoding method comprising:
obtaining an original image;
extracting, from the original image, a common feature map representing a representative task that the original image implies, by using a common feature extraction model based on deep learning;
generating a first bitstream by encoding the common feature map by using a common feature encoder; and
decoding a reconstructed common feature map from the first bitstream by using a common feature decoder and then generating a base image from the reconstructed common feature map by using an image restoration model based on deep learning.

9. The encoding method of claim 8, wherein the common feature extraction model comprises a basic neural network, a decision neural network, and a transformation model, and
wherein the extracting of the common feature map comprises
using the basic neural network for extracting the common feature map from the original image, while generating an analysis result of the representative task based on the common feature map by using the decision neural network and while generating a first transformed image from the common feature map by using the transformation model.

10. The encoding method of claim 9, further comprising:
generating an analysis result by analyzing the representative task based on the common feature map by using the decision neural network;
when the analysis result has cumulative reliability less than a predetermined threshold, extracting, from the original image, a task-specific feature map representing at least one more individual tasks included in the representative task by using a task-feature extraction model based on deep learning; and
generating a second bitstream by encoding the task-specific feature map representing the individual task by using a task feature encoder.

11. The encoding method of claim 10, further comprising, when at least one or more residual tasks are present:
extracting, from the original image, a task-specific feature map representing the residual task by using the task-feature extraction model; and
generating a third bitstream by encoding the task-specific feature map representing the residual task by using the task feature encoder.

12. The encoding method of claim 11, further comprising:
generating a residual image by subtracting the base image from the original image; and
generating a fourth bitstream by encoding the residual image by using a video encoder.

13. The encoding method of claim 12, further comprising:
generating a multiplexed bitstream by combining all or some of the first bitstream, the second bitstream, the third bitstream, and the fourth bitstream.

14. The encoding method of claim 9, wherein the basic neural network is implemented as a multitasking deep learning model.

15. The encoding method of claim 9, wherein the common feature extraction model is trained end-to-end with a weighted sum of a loss function based on a difference between the analysis result and a corresponding label and a loss function based on a difference between the first transformed image and the original image.

16. The encoding method of claim 8, wherein the common feature encoder and the common feature decoder are each implemented by using a codec for video signals or an auto-encoder based on deep learning with the auto-encoder being trained with a loss function based on a difference between the common feature map and the reconstructed common feature map.

17. (canceled)

18. The encoding method of claim 11, wherein the task-feature extraction model comprises a task neural network and a decision neural network, and wherein the extracting of the task-specific feature map comprises:
using the task neural network for extracting the task-specific feature map from the original image, while generating an analysis result of the individual task or the residual task based on the task-specific feature map by using the decision neural network.

19. The encoding method of claim 18, wherein the task-feature extraction model is trained with a loss function based on a difference between the analysis result and a corresponding label.

20. (canceled)

21. The encoding method of claim 9, wherein the generating of the base image comprises:
generating a second transformed image from the reconstructed common feature map by using the transformation model, and then generating the base image from the second transformed image by using the image restoration model.

22. (canceled)

23. A decoding apparatus for machine vision, comprising:
a demultiplexer configured to obtain, from a multiplexed bitstream, a first bitstream that is generated by encoding a common feature map representing a representative task that an original image implies;
a common feature decoder configured to decode the common feature map from the first bitstream; and
a feature-to-image mapper configured to generate a base image from the common feature map by using an image restoration model based on deep learning.

24. (canceled)

25. (canceled)

26. (canceled)
